(19) United States
(12) Patent Application Publication
(10) Pub. No.: US 2009/0160837 A1
(43) Pub. Date: Jun. 25, 2009

(54) DISPLAY HAVING ILLUMINATION FUNCTION

(75) Inventors: HSIU-CHANG LAI, Tu-Cheng (TW); MING-KE CHEN, Shenzhen (CN); KE SUN, Shenzhen (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 11/965,759

(22) Filed: Dec. 28, 2007

(30) Foreign Application Priority Data
Dec. 19, 2007 (CN) 200710203213.4

(51) Int. Cl. G09G 5/00

(52) U.S. Cl. 345/211

(57) ABSTRACT

A display includes a display circuit, a power module connected to the display circuit to supply power thereto, a display card chip, and a switch. The power module is connected to a power pin of the display card chip via the switch. A driving pin of the display card chip is connected to the display circuit and is able to control the display to display a white screen.

### BACKGROUND

1. Field of the Invention

The present invention relates to displays, and particularly to a display which has an illumination function.

2. Description of Related Art

Referring to FIG. 1, a block diagram of a conventional display 100 connected to a computer 200 is illustrated. The display 100 includes a display circuit 120 and a power module 140 configured to supply power to the display circuit 120. When the computer 200 transmits video signals to the display circuit 120, the display 100 will display corresponding video images thereon. However, when the computer 100 isn't operating, the display 100 has no usefulness and the screen is dark.

What is desired, therefore, is to provide a display which has an illumination function.

### SUMMARY

An embodiment of a display includes a display circuit, a power module connected to the display circuit to supply power thereto, a display card chip, and a switch. The power module is connected to a power pin of the display card chip via the switch. A driving pin of the display card chip is connected to the display circuit so the display can have a white screen.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is a block diagram of a conventional display, together with a computer; and

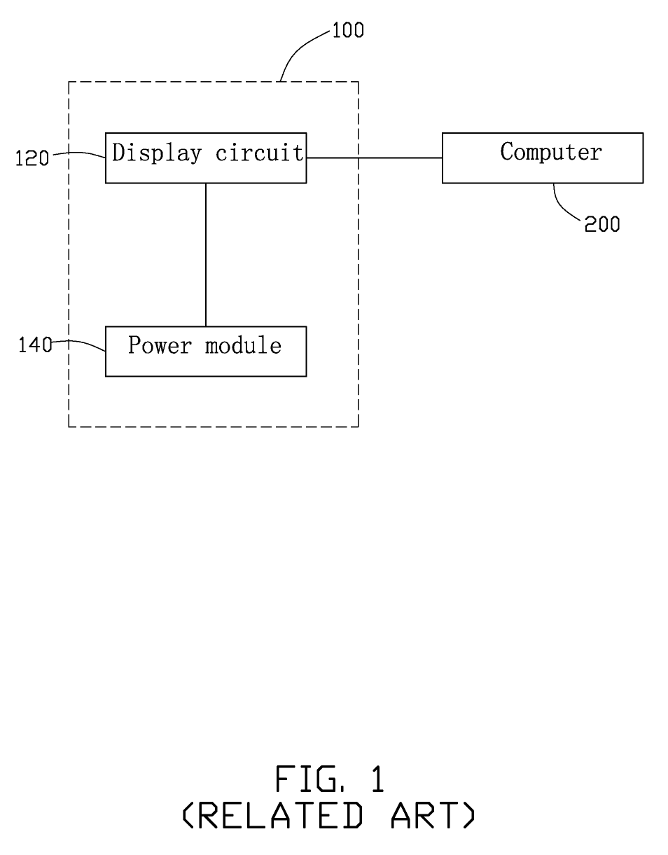

FIG. 2 is a block diagram of a display in accordance with an embodiment of the present invention, together with a computer.

### DETAILED DESCRIPTION

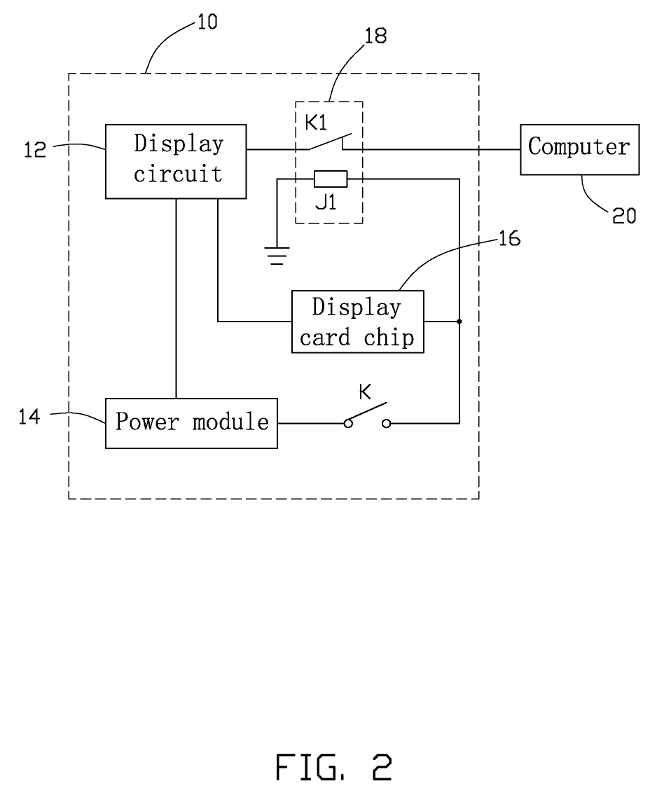

Referring to FIG. 2, a display 10 in accordance with an embodiment of the present invention includes a display circuit 12, a power module 14, a display card chip 16, a relay 18 having a coil J1 and a normally closed switch K1, and switch K.

The power module 14 is connected to the display circuit 12 to supply power to the display circuit 12. The power module 14 is connected to a power pin of the display card chip 16 via the switch K to supply power to the display card chip 16. A driving pin of the display card chip 16 is connected to the display circuit 12 to selectively control the display 10 to have a white screen. The power module 14 is connected to ground via the coil J1 of the switch K. The display circuit 12 is connected to a terminal of the normally closed switch K1. The other terminal of the normally closed switch K1 is configured to connect to a computer 20.

When the computer 20 is connected to the display circuit 12 via the normally closed switch K1, if the computer 20 works and the switch K is turned off. The display 10 will display corresponding video images thereon. If the switch K is turned on, the coil J1 of the relay 18 operates the normally closed switch K1 to be turned on, so that the computer 20 cannot transmit video signals to the display circuit 12. At the same time, the display card chip 16 works and drives the display 10 to have a white screen, thereby the display 10 provides illumination and can function as a lamp.

In other embodiments, the relay 18 can be deleted to save cost. If user needs the display 10 to be used as a lamp, the user can cut off the computer 20 and turn on the switch K, and then the display 10 has the illumination function, which is very convenient.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A display comprising:
a display circuit;
a power module connected to the display circuit to supply power thereto;
a display card chip; and
a switch, the power module connected to a power pin of the display card chip via the switch, a driving pin of the display card chip connected to the display circuit able to drive the display to display a white screen.

2. The display as claimed in claim 1, further comprising a relay having a coil and a normally closed switch, the power module connected to ground via the coil of the switch, the display circuit connected to a terminal of the normally closed switch, the other terminal of the normally closed switch configured to connect to a video device.

3. The display as claimed in claim 3, wherein the video device is a computer.
